(19) United States
(12) Patent Application Publication
(10) Pub. No.: US 2016/0242407 A1
(43) Pub. Date: Aug. 25, 2016

(54) WILD GAME CALL METHOD AND APPARATUS

(71) Applicant: BIG SHOT, LLC, Hawkins, TX (US)

(72) Inventors: Benjamin Franklin, Holly Lake Ranch, TX (US); Byron South, Big Sandy, TX (US); Wayne Chappell, Euless, TX (US); Regis Wandres, Canton, TX (US)

(21) Appl. No.: 14/995,630

(22) Filed: Jan. 14, 2016

Related U.S. Application Data
(60) Provisional application No. 62/104,435, filed on Jan. 16, 2015.

(51) Int. Cl. A01M 31/00; H04W 4/00; A01M 31/06

(52) U.S. Cl. CPC A01M 31/004; A01M 31/06; H04W 4/008

(57) ABSTRACT

A game call device including a housing formed having a housing assembly telescopingly movable within a shell assembly, the housing assembly movable between a storage position, to facilitate storage and transport of the device, and a use position, to facilitate use of the device. The device further includes a communications module for communicating between a remote device and the housing, the communications module operable to transmit a signal to the housing via a first audio channel for providing a sound, and a second audio channel, for rotating a decoy.

### CROSS-REFERENCE TO RELATED APPLICATIONS

This application claims priority to U.S. Provisional Patent Application No. 62/104,435, filed Jan. 16, 2015, which is incorporated herein by reference in its entirety.

### TECHNICAL FIELD

This disclosure relates to wild game calls, and in particular, to an electronic wild game call.

### BACKGROUND

Hunters oftentimes use of game calls in order to attract an animal being hunted. Such game calls are typically used in rugged environments and are exposed to harsh weather conditions, which increases the likelihood of damage to the units. Furthermore, while the types of wild game calls can vary, many devices are highly customized, costly, and have limited end-user options and control. Thus, there is a need for a wild game call to address these and other issues.

### SUMMARY OF THE INVENTION

In one embodiment of the present invention, the apparatus comprises a Bluetooth communication module for pairing with a Bluetooth capable host. The apparatus comprises a motorized element and speaker system. According to one embodiment, the present system is internally powered by a rechargeable on-board battery. The general mechanical and electronics configuration of the apparatus enhances the device's communication range, increases the device's audible range, the visible range of the motorized element, while not becoming an obvious man-made object to fauna. Furthermore, the device's shape is conducive to improved environmental endurance and ease of transportability.

### BRIEF DESCRIPTION OF THE DRAWINGS

FIG. 1 is a perspective view of the wild game call in a retracted position.

FIG. 2 is a perspective view of the wild game call of FIG. 1 in an expanded position.

FIG. 3 is a perspective view of a portion of the wild game call of FIGS. 1 and 2.

FIG. 4 is a perspective view of yet another portion of the wild game call of FIGS. 1 and 2.

FIG. 5 is a view of a portion of the wild game call with a decoy mounted thereon.

FIG. 6 is a bottom perspective view of a portion of the wild game call of FIGS. 1-5, with a portion of the exterior surface of the game call removed.

FIG. 7 is a bottom perspective view of the wild game call of FIGS. 1-6 in the expanded position.

FIG. 8 is a schematic block diagram of the wild game call of FIGS. 1-7.

FIG. 9 is a front view of a smart phone including a user interface to operate the wild game call of FIGS. 1-7.

FIG. 10 is a left side view of the wild game call illustrated in FIG. 2.

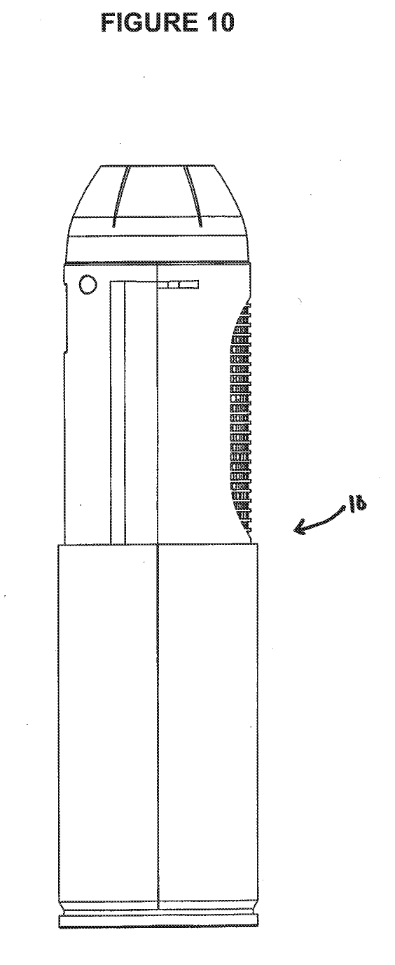

FIG. 11 is a front view of the wild game call illustrated in FIG. 2.

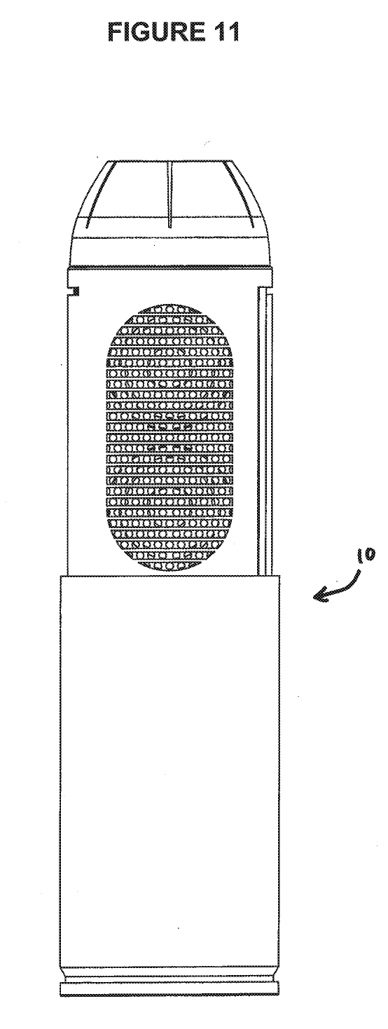

FIG. 12 is a right side view of the wild game call illustrated in FIG. 2.

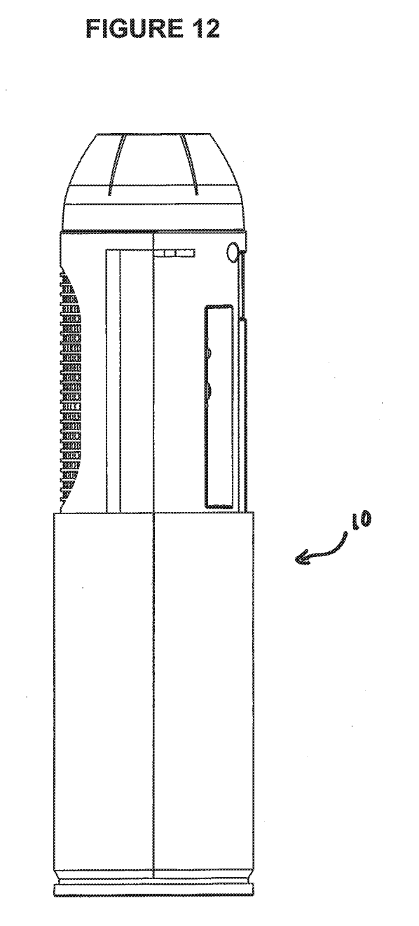

FIG. 13 is a rear view of the wild game call illustrated in FIG. 2.

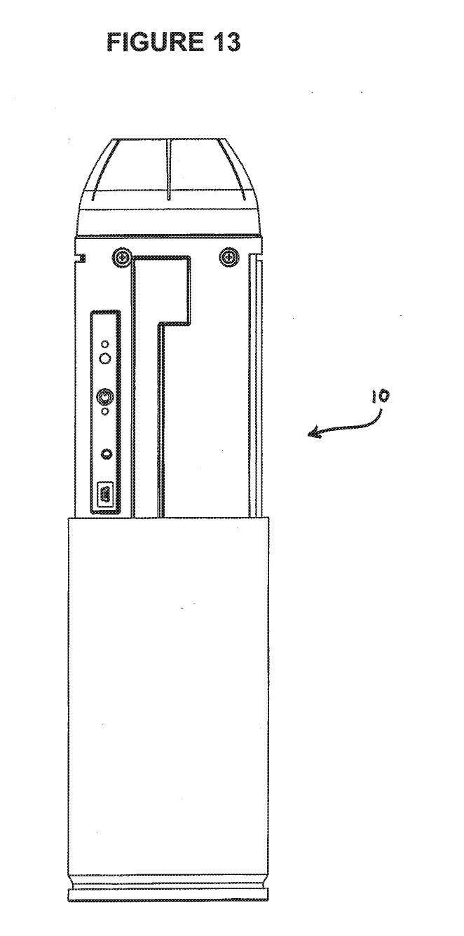

FIG. 14 is a front view of the wild game in the collapsed position, the rear and side views being in mirror thereof.

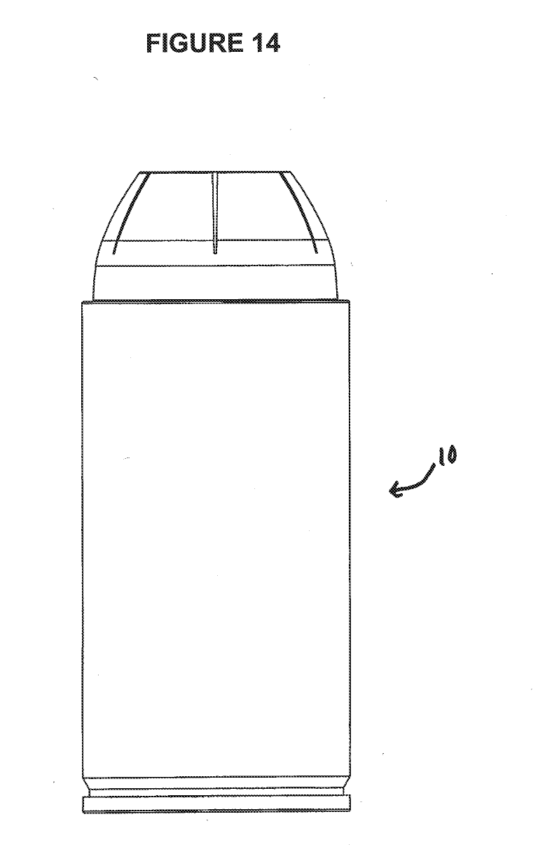

FIG. 15 is a top plan view of the wild game call of FIGS. 1-14.

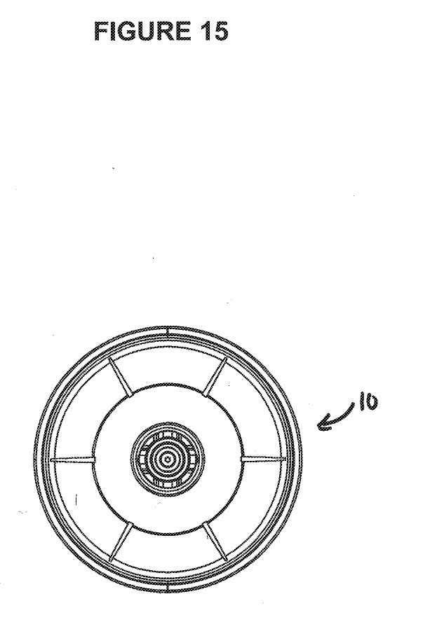

FIG. 16 is a bottom plan view of the wild game call of FIGS. 1-15

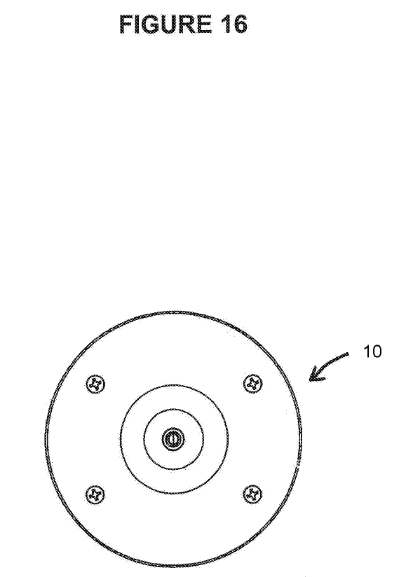

### DETAILED DESCRIPTION

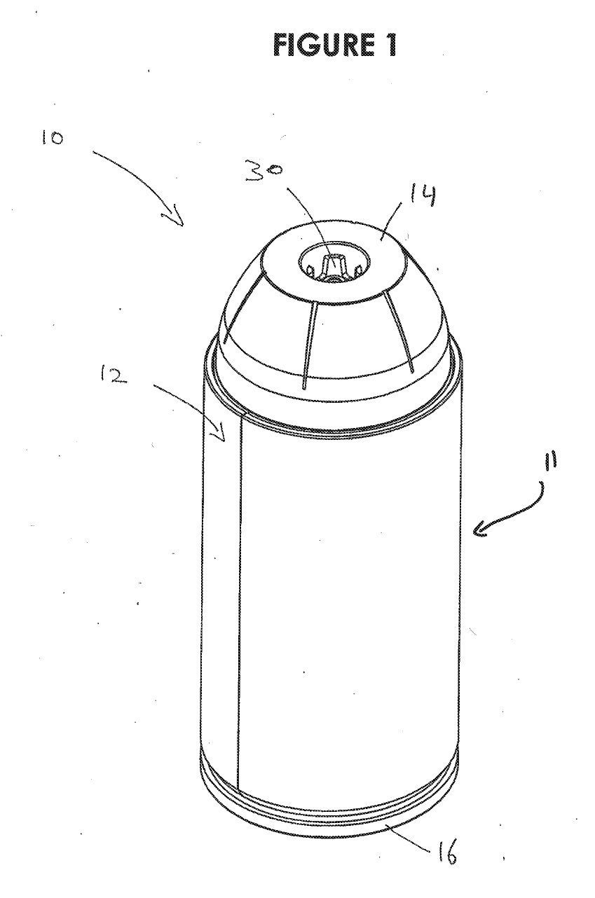

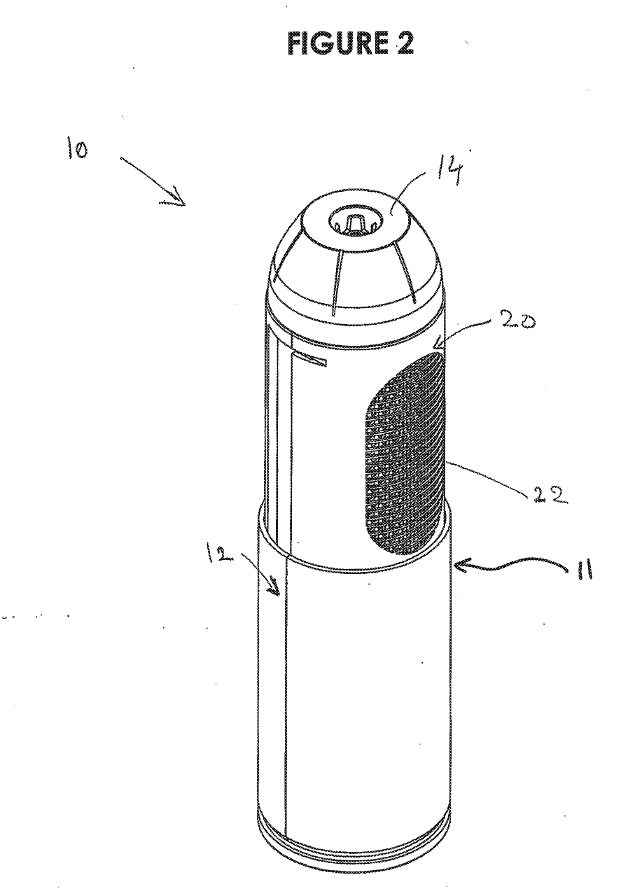

In the embodiment illustrated in FIGS. 1 and 2, there is provided a wild game call 10 positionable between a collapsed position (FIG. 1) for transport and/or storage, and an extended/use position (FIG. 2). In FIGS. 1 and 2, game call 10 is formed having a housing 11, the housing 11 including an outer shell 12 and an inner shell 20 telescopingly movable within the outer shell 12. The housing 11 physically protects internal elements of the game call 10. For example, the housing 11 provides a primary layer of dirt and water ingress prevention, as well as other possible mechanical interference from outside environment. In one embodiment, the shell 12 is composed of impact resistant polymeric material with ultra-violet treatment so that the polymeric material is impervious to the degrading effects of solar rays. It should be understood, however, that the shell 12 may be formed of any material with or without the ultra-violet treatment.

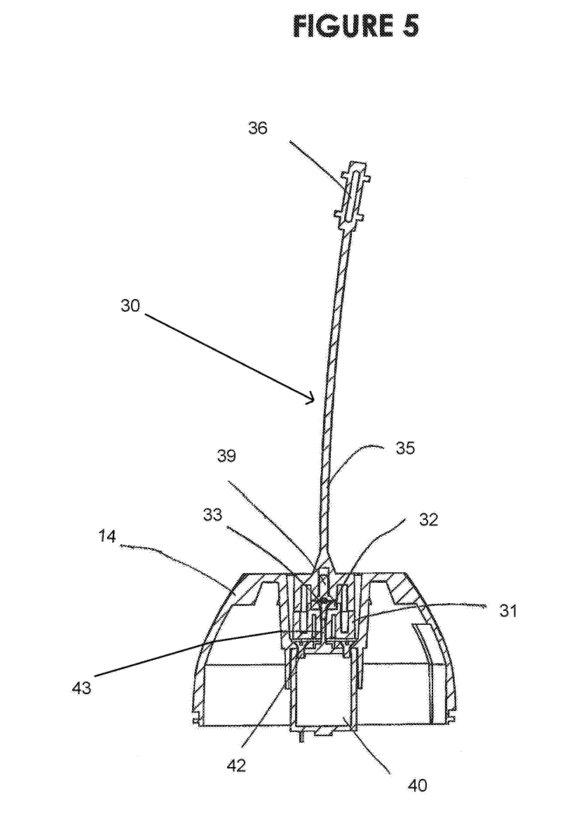

Referring specifically to FIG. 1, the shell assembly 12 includes a base 16 and the housing assembly 20 includes a top cap 14. In operation, the top cap 14 is rotatable relative to the shell assembly 12 clockwise and counterclockwise to lock and unlock the caller 10 in the respective expanded or retracted positions. The top cap 14 also houses a motor coupler assembly 30, as best illustrated in FIG. 5. Similar to the shell assembly 12, the base 16 is made of a polymeric material. Base 16 provides a generally planar surface to support the game call 10 on a support surface and also provides mechanical protection to other elements of the game call 10.

Referring specifically to FIG. 2, the game call 10 is in the extended position. In this configuration, the top cap 14 and the housing assembly 20 are mechanically shifted vertically above shell assembly 12. In the embodiment illustrated in FIG. 2, the housing assembly 20 includes a speaker grill 22 formed on the sidewall of the housing assembly 20. The ability to configure the present game call in the extended configuration increases vertical distance between the speaker grill 22 and a support surface, such as the ground. The vertical distance improves both system acoustical range and system Bluetooth radio frequency range. In one embodiment, the housing assembly 20 is formed of the same polymeric materials as the shell assembly 12, having similar characteristics. The housing assembly 20 provides a secondary layer of environmental protection to inner elements of the present game call 10. When in the retracted position, the top cap 14 and the housing assembly 20 are rotatable to facilitate positioning of the game call 10 in the extended/use position. In an important aspect of the present invention, the mechanical assembly of top cap 14 with housing assembly 20 forms a water resistant barrier, protecting elements housed inside said mechanical assembly.

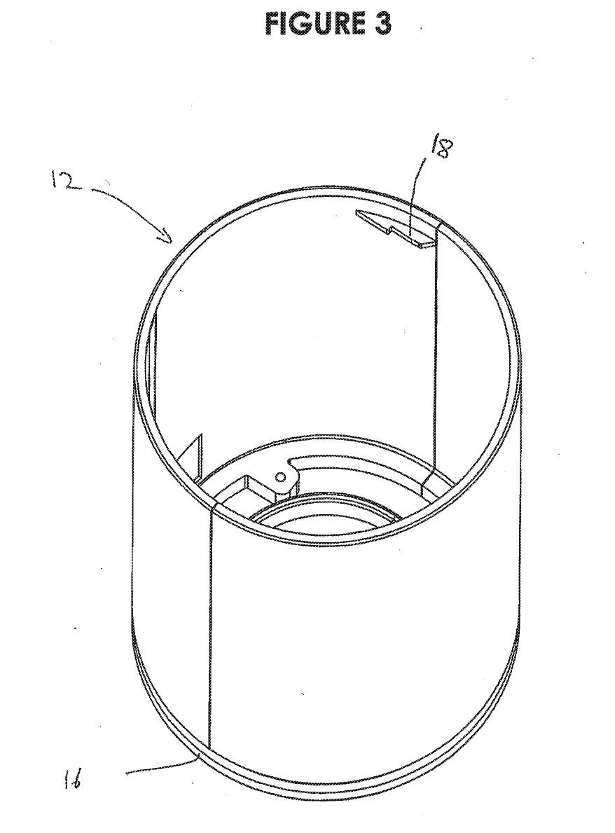

Looking at FIG. 3, there is shown a perspective view of the shell assembly 12 and the base 16. In an important aspect of the game call 10, the shell assembly 12 features a pair of locking protrusions 18. In FIG. 3, only one of the locking protrusions 18 is visible; however, it should be understood that a greater or fewer number of locking protrusions 18 may be used.

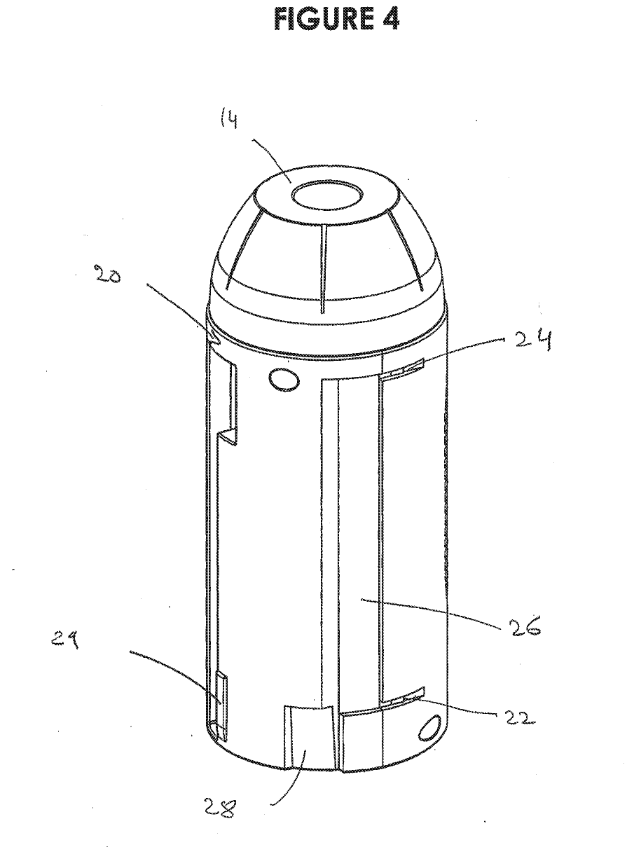

Now turning to FIG. 4, there is shown a perspective view of mechanical assembly of the top cap 14 with the housing assembly 20. The housing assembly 20 presents a combination of features consisting of lower locking recess 22, an upper locking recess 24, a transitioning rail 26, and an install ramp 28. Diametrically opposite combination of features are optionally present on opposite side of the housing assembly 20, which is not illustrated. When the game call 10 is in its retracted configuration, the upper locking recess 24 is engaged with a locking protrusion 18, which prevents movement of the housing assembly 20 relative to the shell assembly 12. Likewise, when the game call 10 is in its extended configuration, the lower locking recess 22 is engaged with the locking protrusion 18 to prevent relative telescoping movement between the shell assembly 12 and the housing 20. According to some embodiments, the locking protrusion 18 features a step and/or otherwise sloped surface that is generally complementary in shape to a corresponding surface on the lower locking recess 22 and the upper lower recess 24. The mating of those opposing steps/surfaces provides a resistance to rotation of the housing assembly 20 about its longitudinal axis, effectively forming a locking mechanism. The resistance can be overcome by means of exerting sufficient force, resulting in elastic deformation of the shell assembly 12 allowing release of the locking mechanism.

In another important aspect, the housing assembly 20 also includes a transition rail 26, which provides a physical guide or “track” for the locking protrusion 18 to travel within while transitioning the game call 10 between the extended and retracted positions. In some embodiments, an install ramp 28 facilitates initial assembly of the housing assembly 20 with the shell assembly 12. In particular, when it is desired to secure the housing assembly 20 within the shell assembly 12, each locking protrusion 18 is aligned with a respective ramp 28. The housing assembly 20 is then inserted within the shell 12 and the locking protrusions travel along the incline of the ramp 28. As the protrusions travel along the ramp 28, they are deflected and/or otherwise retraced so as to be inserted within the respective lower locking recess 22. Once inserted therein, the locking protrusion remains within the locking recess 22 and/or the transitioning rail 26 since the inclined ramp 28 blocks the protrusion from being removed therefrom.

As illustrated in FIG. 4, housing assembly 20 also features one or more interfering protrusions 29 (only one shown). The interfering protrusions 29 provide a radial interference fit with the shell Assembly 12 aiding the rigidity of assembly between the shell assembly 12 and the housing assembly 20.

Referring now to FIG. 5, there is shown a front partial section view of the present game call 10. A motorized element 40 is secured to the top cap 14 using one or more screws 42. In one embodiment, the motorized element 40 is a battery powered motor and includes an output shaft 43. The shaft 43 frictionally engages a motor coupler 31. A magnet 32 is secured to the motor coupler 31 using a screw 33. A screw 34 or other attachment mechanism is secured to a decoy 35. According to one aspect, the decoy 35 is magnetically coupled with motor coupler 31. The entire combination of elements described in this section is actuated by the motorized element 40, as described in greater detail below. A slot 36 disposed at the top of the decoy 35 provides an installation means for decoy materials such as, but not limited to, ribbons, feathers and the like. In operation, the energizing of the motorized element 40 rotates the output shaft 43 to provide visual movement of decoy materials.

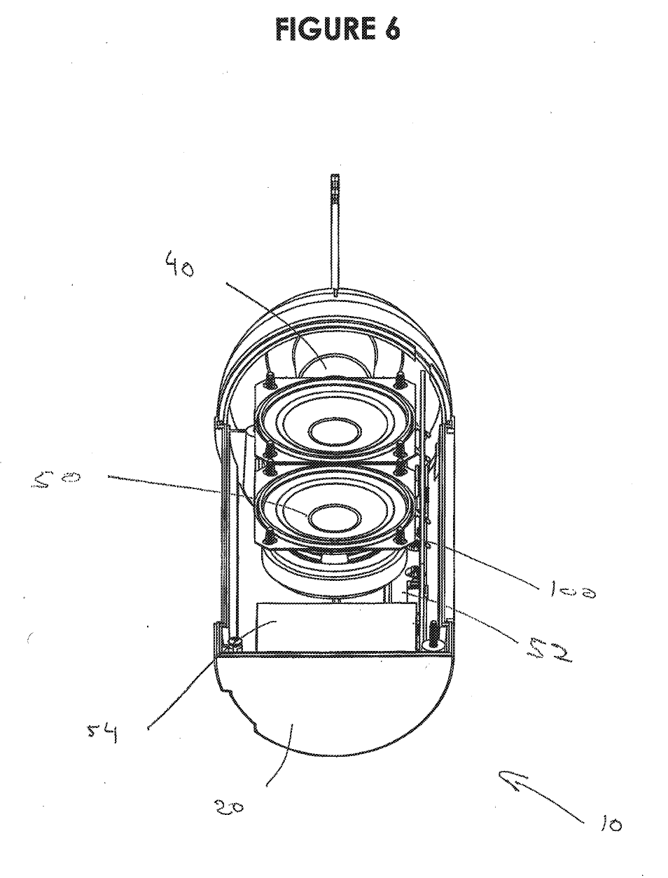

Referring to FIG. 6, there is shown a partial perspective view of the game call 10 with a section of the housing assembly 20 removed. A speaker system 50 provides audible range acoustical sound. A user Interface 52 provides a user a mechanical means of interacting with a control module 100. The user interface includes, for example, a power button, a power port, a USB port and the like. A battery 54 provides energy to the control module 100; however, it should be understood that other methods of powering the control module 100 may be used (solar, etc.). The control module 100 provides controlled power to the speaker system 50 and the motorized element 40, as explained in greater detail below.

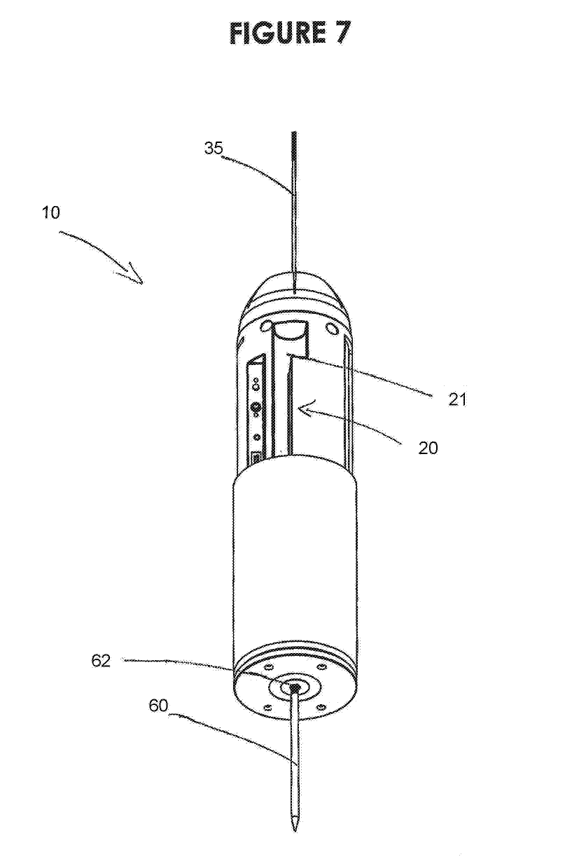

Referring now to FIG. 7, an extension or spike member 60 is secured to the base 16.

According to some embodiments, the spike is secured to the base 16 via a threaded insert 62; however, it should be understood that the spike 60 may be otherwise attached (i.e., via an adhesive or otherwise) or may be formed integral with the base 16. The spike 60 provides a mechanism to secure game call 10 to a penetrable surface such as the ground. In another embodiment, the spike 60 is replaced with a tripod (not illustrated) allowing further additional height to the game call 10 while in use. According to some embodiments, the housing assembly 20 provides a storage recess 21 to stowaway the spike 60 and the decoy 35 when game call 10 is in retracted configuration and/or when the spike 60 is not needed.

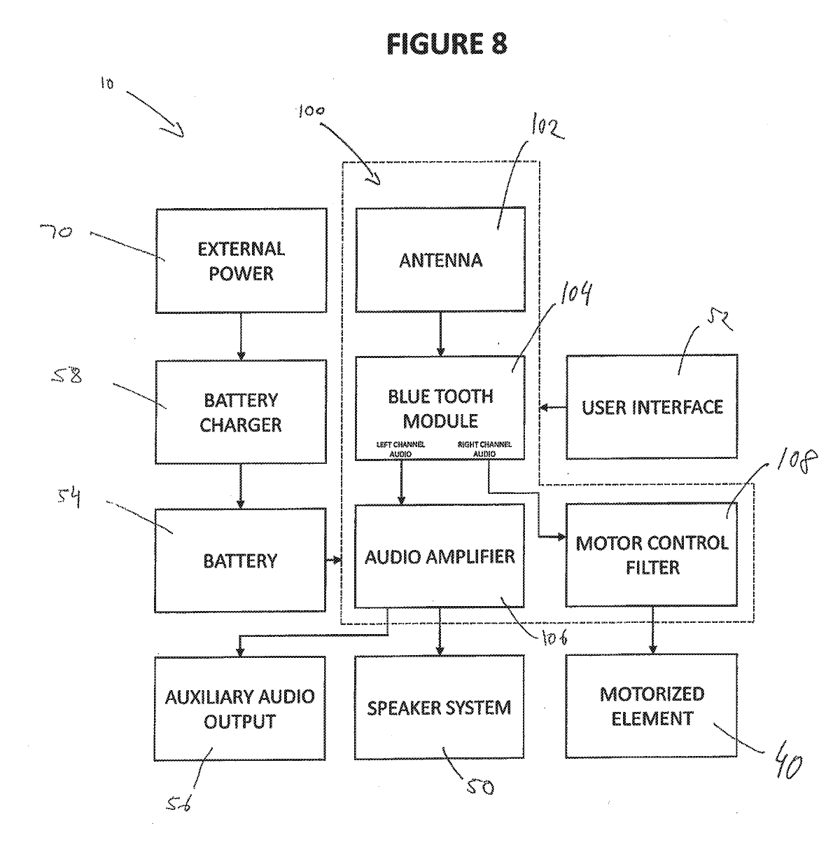

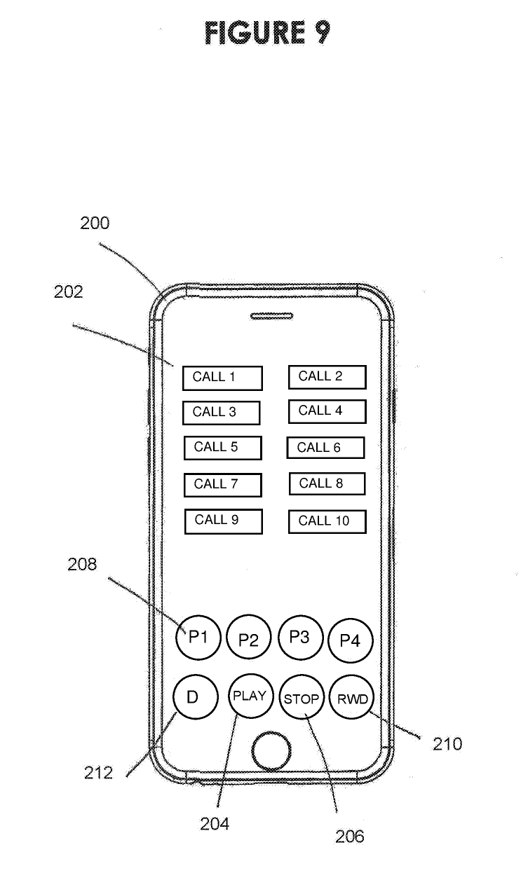

Now turning to FIG. 8, there is shown a functional block diagram of Invention 10. The control module 100 includes a radio frequency antenna 102, a Bluetooth module 104, an audio amplifier 106, and a motor control filter 108. According to one aspect, a stereo audio signal is transmitted from a host device 200, such as a cell phone (FIG. 9) whereas the stereo signal is an audible sound on left channel and the stereo signal is a set of specific frequencies on right channel. Note that in another embodiment, this process can be reversed. In operation, the stereo radio signal from host device 200 is detected by the antenna 102 and fed to the Bluetooth module 104. The Bluetooth module 104 provides audio sound waves to the audio amplifier 106 via the Bluetooth module 104 left channel audio, and the Bluetooth module 104 provides audio sound waves to the motor control filter 108 from the Bluetooth module 104 right channel audio, or vice-versa. The audio amplifier 106 provides amplified audio wave signals to the speaker system 50 or, if connected to an external device, audio wave signals to the auxiliary audio output 56.

In an important aspect of the present Invention, motor control filter 108 monitors the frequencies of the right channel audio provided by Bluetooth Module 104. Motor control filter 108 comprises a low band frequency filter and a high band frequency filter. If audio signal frequency is outside both low and high band filters, no energy is applied to the motorized element 40. If audio signal frequency is within low band frequency filter, polarized energy is applied to the motorized element 40 to create a motion; if audio signal frequency is within high band filter, reversed polarized energy is applied to motorized element 40 to create a different motion. For example, in some embodiments, when the audio signal frequency is within the low band frequency filter, the polarized energy is applied to the motorized element 40 to rotate in a clockwise direction. Likewise, when the audio signal frequency is within the high band frequency filter, the polarized energy is applied to the motorized element 40 to rotate in a counter-clockwise direction. In other embodiments, however, the motorized element 40 may include a solenoid, a piston, or any other type of mechanical or electromechanical device.

Other elements of the game call 10 include a user interface 52 for function control of the control module 100, a battery 54 that provides power to the control module 100, a battery charger 58 to recharge the battery 54, when the battery charger 58 is energized by external power 70.

Now turning to FIG. 9, a front view of a smart phone 200 is illustrated. According to embodiments disclosed herein, the game call utilizes a universally available built-in Bluetooth module present in all marketed smart phones. Specifically, the Invention makes use of either the Bluetooth protocol profile “A2DP” (Advanced Audio Distribution Profile) or “GAVDP” (Generic Audio/Video Distribution Profile) because these two Bluetooth profiles are known to be universally available smart phones, thereby ensuring that game call 10 will successfully communicate smart phones no matter what market, model and/or user. In operation of the present game call 10, the Bluetooth profiles are used not only for actual audible sound transmission and playback over a speaker system, but also to control a the motorized element.

Now further detailing the software ecosystem interaction between the smart phone 200 and the game call 10, the smart phone 200 is programmed with an “App” specific to this application. The “App” core functions are detailed in the below paragraph and as shown on FIG. 9.

In use, the “App” provides user with choices of audible sounds to be played over the speaker system of the game call 10. Audible sounds are selected via a menu and, in this preferred embodiment, consisting of a series of clickable boxes 202, labeled, for example “CALL 1; CALL 2” and so on. Once an audible sound is selected, the user can begin the broadcast of the sound by tapping button “PLAY” 204 or stop playing selected sound by tapping button “STOP” 206. According to one embodiment of the present “App”, the user also has the ability to set preset sounds via preset button “P1; P2” 208 and so on. Pressing button “RWD” 210 reverts system to play the previously selected sound. According to other aspect, the “App” includes a decoy button “D” 212. Tapping “D” 212 toggles the app between transmitting or not transmitting a command sound, in turn energizing or not energizing the motorized element.

According to yet other aspects, the “App” does not interfere with other functions of the smart phone 200 nor transmit standard voice calls/sounds to the phone 200.

What is claimed is:

1. A game call device communicatively coupled to a remote device, the came call device comprising:
a motor;
a decoy rotatably coupled to the motor;
a control module for receiving an audio signal from the remote device, the signal having a first audio channel portion and a second audio channel portion, wherein the control module sends the first audio channel portion to an audio output system to produce an audio sound and sends the second audio channel portion signal to a motor control system to enable the motor to rotate the decoy;
the motor control system including a first band frequency filter and a second band frequency filter, wherein if the second channel audio portion of the signal is within the first band frequency filter, energy is applied to the motor to rotate the decoy at a predetermined speed and direction, and wherein if the second audio channel portion of the signal is within the second band frequency filter, energy is applied to the motor to rotate the decoy in a second predetermined speed and direction.

2. The game call device of claim 1, wherein the signal is a stereo signal comprising the first channel portion and the second channel portion.

3. The game call device of claim 1, wherein the first band frequency filter is a low band frequency filter.

4. The game call device of claim 1, wherein the second band frequency filter is a high band frequency filter.

5. The game call device of claim 1, wherein the audio output system includes an audio amplifier and a speaker.

6. The game call device of claim 1, wherein if the first channel portion of the signal and the second channel portion of the signal are not within the first band frequency filter or the second band frequency filter, the motor will not rotate.

7. The game call device of claim 1, wherein the control module includes an antenna to receive a Bluetooth signal.

8. The game call device of claim 1, further comprising a rechargeable battery.

9. The game call device of claim 1, further comprising a telescoping housing positioned between a collapsed position for storage, and an extended position for use of the device.

10. A game call method, the method comprising:
receiving an audio signal from a remote device;
in response to receiving the signal,
sending a first channel portion of the signal to an output system to produce a sound; and
sending a second channel portion of the signal to a motor control system such that if the second channel portion contains a first predetermined frequency, energy is applied to a motor to move a decoy at a predetermined speed and direction, and wherein if the second channel portion of the signal is within the second predetermined frequency, energy is applied to the motor to move the decoy in a second predetermined speed and direction.

11. The method of claim 10, wherein receiving the signal includes receiving the signal via a Bluetooth communication protocol.

12. The method of claim 10, wherein receiving the signal includes receiving stereo signal via a Bluetooth communications protocol.

13. The method of claim 10, wherein moving the decoy in the first or second predetermined speed and direction comprises rotatably moving the decoy.

14. A method of manufacturing a game call device that is communicatively coupleable to a remote command device, the method comprising:
providing a housing
inserting a motor within the housing;
coupling a decoy to the motor;
securing a control module in the housing, the control module operable to receive an audio signal from the remote device, the signal having a first channel portion and a second channel portion, wherein the control module sends the first channel portion to an audio output system to produce an audio sound, and sends the second channel portion signal to a motor control system to enable the motor to move the decoy; and
providing a first band frequency filter and a second band frequency filter in the motor control system wherein if the second channel portion of the signal is within the first band frequency filter, the motor control system applies energy to the motor to move the decoy at a first desired motion, and wherein if the second channel portion of the signal is within the second band frequency filter, the motor control system applies energy to move the decoy in a second desired motion.

15. The method of claim 14, wherein providing the housing comprises providing a housing a having a first portion and a second portion telescopingly engageable with the first portion.

16. The method of claim 14, further comprising providing a speaker in the housing.

17. The method of claim 14, wherein providing a first band frequency filter comprises providing a low band frequency filter.

18. The method of claim 14, wherein providing a second band frequency filter comprises providing a high band frequency filter.

19. The method of claim of claim 14, further comprising providing an antenna to receive a Bluetooth signal from the remote device.

20. The method of claim 14, wherein coupling a decoy to the motor comprising rotatably coupling the decoy to the motor.
